(19) United States
(12) Patent Application Publication
(10) Pub. No.: US 2026/0316518 A1
(43) Pub. Date: Oct. 15, 2026

(54) MULTI-WAY VALVE FOR A FLUID CIRCUIT

(71) Applicant: VALEO SYSTEMES THERMIQUES, Le Mesnil-Saint-Denis (FR)

(72) Inventors: Moussa Nacer-Bey, Le Mesnil-Saint-Denis Cedex (FR); Kamel Azzouz, Le Mesnil-Saint-Denis Cedex (FR); Sebastien Garnier, Le Mesnil-Saint-Denis Cedex (FR); Julien Tissot, Le Mesnil-Saint-Denis Cedex (FR)

(73) Assignee: VALEO SYSTEMES THERMIQUES, Le Mesnil-Saint-Denis (FR)

(21) Appl. No.: 19/117,088

(22) PCT Filed: Sep. 13, 2023
(86) PCT No.: PCT/EP2023/075077

§ 371 Date: Mar. 31, 2025

(30) Foreign Application Priority Data
Oct. 5, 2022 (FR) FR2210211

(51) Int. Cl. B60H 1/00; F16K 11/076; F16K 27/12; F16K 31/53

(52) U.S. Cl. CPC B60H 1/00485; F16K 11/076; F16K 27/12; F16K 31/535

(57) ABSTRACT

A multi-way valve includes a body having a first housing and a first series of orifices opening into said housing; a first rotary member rotatably movable in the first housing, which member controls the circulation of fluid between the orifices of said first series; a second housing arranged in the body, which second housing is adjacent to the first housing and in the same plane; a second series of orifices arranged in the body, which orifices open into the second housing; a second rotary member rotatably movable in the second housing, which member controls the circulation of fluid between the orifices of the second series; a common channel or duct connects the two housings; and an orifice opens into the common channel or duct and onto an outer surface of the body.

### TECHNICAL FIELD

The present invention relates to a multi-way valve for a fluid circuit. The invention also relates to a heat exchanger system comprising such a valve and to a motor vehicle comprising such a system.

The invention relates in particular to the technical field of multi-way valves having several fluid inlet/outlet orifices.

### PRIOR ART

The size of the components in a fluid circuit is a major constraint, especially in the field of motor vehicles when seeking to miniaturize them in order to reduce the space they occupy. In the context of a heat exchanger, one of the solutions is to make all the components of the heat exchanger compact.

Multi-way valves answer to this problem in the sense that they generally combine a certain number of valves into a single valve.

In particular, patent documents WO2021/121922 and CN110118269A disclose multi-way valves of the type comprising a valve body having a housing. A first series of fluid inlet and/or outlet orifices and a second series of fluid inlet and/or outlet orifices open onto an outer surface of the valve body at different stages. A rotary member is mounted so as to be rotatable in the housing about an axis of rotation normal to the planes, in such a way that said member adopts different angular positions in which the various orifices of the series are closed off or left free in order to control the circulation of fluid between said orifices.

However, these valves have drawbacks. Firstly, these valves are staged, so that their overall axial size is quite considerable. In addition, the number of fluid circulation paths (or operating modes) is limited.

The aim of the invention is to overcome the drawbacks of the aforementioned prior art. More particularly, the aim of the invention is to propose a multi-way valve whose overall axial size is small. Another aim of the invention is to propose a multi-way valve making it possible to offer more operating modes. Yet another aim of the invention is to propose a multi-way valve whose design and assembly are easy and whose operation is simple.

### Presentation of the Invention

The solution proposed by the invention is a multi-way valve comprising:
a one-piece valve body in which is arranged a first housing, and a first series of fluid inlet and/or outlet orifices, said orifices opening into said first housing,
a first rotary member mounted movably in rotation in the first housing about a first axis of rotation, such that said first member adopts different angular positions, said first member being adapted to control the circulation of fluid between the orifices of said first series according to said angular positions, and in which:
a second housing is arranged in the body, which second housing is adjacent to the first housing and is located in the same plane as said first housing,
a second series of fluid inlet and/or outlet orifices is arranged in the body, said orifices opening into the second housing,
a second rotary member is mounted movably in rotation in the second housing about a second axis of rotation which is distinct from and parallel to the first axis of rotation, such that said second member adopts different angular positions, said second member being adapted to control the circulation of fluid between the orifices of the second series according to said angular positions,
a common channel or duct connects the first and second housings so as to allow fluidic communication between said housings,
a common fluid inlet and/or outlet orifice is arranged in the body, which orifice opens on the one hand into the common channel or duct and on the other hand onto an outer surface of the body.

The fact that two rotary members control the circulation of fluid between the orifices of the first series, combined with the fact that the two housings can be in fluidic communication, allows the number of possible operating modes to be greatly multiplied compared with the multi-way valves of the prior art. In addition, each rotary member can adopt different angular positions independently of each other, which further increases the number of operating modes. Furthermore, the fact that the two housings and their respective rotary member are in the same plane makes it possible to obtain a small overall axial size. The multi-way valve according to the invention makes it possible, for example, to combine several three-way valves or several four-way valves. Finally, the use of two different rotary members allows each of them to be designed in a specific manner so as to very easily offer all the combinations suitable for the required operating modes.

Other advantageous features of the invention (in its various aspects) are listed below. Each of these features may be considered alone or in combination with the notable features defined above. Each of these features contributes, as appropriate, to solving specific technical problems defined earlier on in the description, to which problems the notable features defined hereinabove do not necessarily contribute. These may, where appropriate, form the subject matter of one or more divisional patent applications:

According to one embodiment, a first actuator rotates the first rotary member, and a second actuator, separate from said first actuator, rotates the second rotary member.

According to a variant embodiment, a common actuator ensures the simultaneous rotation of the first rotary member and of the second rotary member, by way of a device with gears or pinions meshed with said members.

According to one embodiment, the first rotary member is configured so as to have angular positions allowing circulation of fluid between at least two orifices of the first series and/or between at least one orifice of said first series and the common channel or duct.

According to one embodiment, the second rotary member is configured so as to have angular positions allowing circulation of fluid between at least two orifices of the second series and/or between at least one orifice of said second series and the common channel or duct.

According to one embodiment, the first rotary member has a central cavity surrounded by a partition, said partition comprising two adjacent first apertures distributed over 60°, a first solid portion covering 30°, two adjacent second apertures distributed over 60°, a second solid portion covering 30°, a third aperture distributed over 30°, a solid portion covering 150° and located between the third aperture and the first apertures, which apertures complement the orifices of the first series and the common channel or duct.

According to one embodiment, the second rotary member has two distinct cavities without fluidic communication between said cavities, which cavities are surrounded by a partition, said partition comprising four apertures offset by 90° and complementary to the orifices of the second series and the common channel or duct, two apertures being disposed at the first cavity and two apertures being disposed at the second cavity.

According to one embodiment, a sealing element is installed in the common channel or duct and in the housings, between the valve body and the rotary members, which sealing element has first openings complementary to the orifices of the first series and second openings complementary to the orifices of the second series, so as to form a seal to the fluid between, on the one hand, the first rotary member and the orifices of said first series and, on the other hand, between the second rotary member and the orifices of said second series.

According to one embodiment, the sealing element comprises a connecting portion complementary to the common channel or duct, which connecting portion has two openings that open respectively into the first housing and into the second housing, so as to form a seal to the fluid between, on the one hand, the first rotary member and said common channel or duct and, on the other hand, between the second rotary member and said common channel or duct.

According to one embodiment, the central cavity of the first rotary member is closed in a leaktight manner by a first sealing cover, and the cavities of the second rotary member are closed in a leaktight manner by a second sealing cover; or the central cavity of the first rotary member and the cavities of the second rotary member are closed in a leaktight manner by a common sealing cover.

According to one embodiment, the actuator or actuators are fixed to a cover sealing the valve body.

Another aspect of the invention relates to a heat exchanger system comprising a heat exchanger, a first fluid circulation circuit and a second fluid circulation circuit. in which the first circuit and the second circuit are connected to a multi-way valve according to any of the preceding features, orifices of the first series being in fluidic connection with the first circuit and orifices of the second series being in fluidic connection with the second circuit.

According to one embodiment, the first circuit and/or the second circuit comprise one or more devices for regulating the circulation of the fluid, said one or more devices being arranged to block or permit circulation of the fluid from or to one or more orifices of the first and/or second series.

Yet another aspect of the invention relates to a motor vehicle comprising a heat exchanger system configured to allow cooling and/or heating of the passenger compartment of the vehicle and/or parts of said vehicle, which heat exchanger system is in accordance with any one of the preceding features.

### BRIEF DESCRIPTION OF THE FIGURES

Further advantages and features of the invention will become more clearly apparent from reading the following description of a preferred embodiment, with reference to the appended drawings, which are provided by way of non-limiting indicative examples and in which:

FIG. 1A is a perspective view of a valve body of a valve according to the invention.

FIG. 1B is a longitudinal sectional view of the valve body from FIG. 1A.

FIG. 2A is a perspective view of a first rotary member of a valve according to the invention.

FIG. 2B is a transverse sectional view of the first member from FIG. 2A.

FIG. 3 is a perspective view of a second rotary member of a valve according to the invention.

FIG. 3B is a transverse sectional view of the second member from FIG. 3A.

FIG. 4A is a perspective view of a sealing element capable of being installed in a valve according to the invention.

FIG. 4B is a longitudinal sectional view of the sealing element from FIG. 4A.

FIG. 5 is a longitudinal sectional view of a valve according to the invention, with its various constituent elements in the assembled state.

FIG. 6 is a perspective view of a valve according to the invention.

FIG. 7 is an exploded view of a valve according to the invention.

FIG. 8A, FIG. 8B, FIG. 8C, FIG. 8D, FIG. 8E, FIG. 8F, FIG. 8G, FIG. 8H and

FIG. 9 schematically illustrate the operation of a valve according to the invention in different angular positions of the rotary members.

FIG. 10A, FIG. 10B and FIG. 10C illustrate a fluid circulation circuit in a heat exchanger system according to the invention and according to various operating modes.

### DESCRIPTION OF THE EMBODIMENTS

To supplement their current definition, the following clarifications are made in respect of certain terms used in the claims and description:
As used herein, and unless stated otherwise, the use of the ordinal adjectives “first”, “second”, etc., to describe an object merely indicates that different instances of similar objects are being referred to and does not imply that the objects so described must be in any given sequence, whether in time, space, order of rank, etc.
“X and/or Y” means: X alone or Y alone or X+Y.
In general, it will be appreciated that, in the various attached figures, the objects have been drawn arbitrarily in order to make the drawings easier to read.

### Valve Body

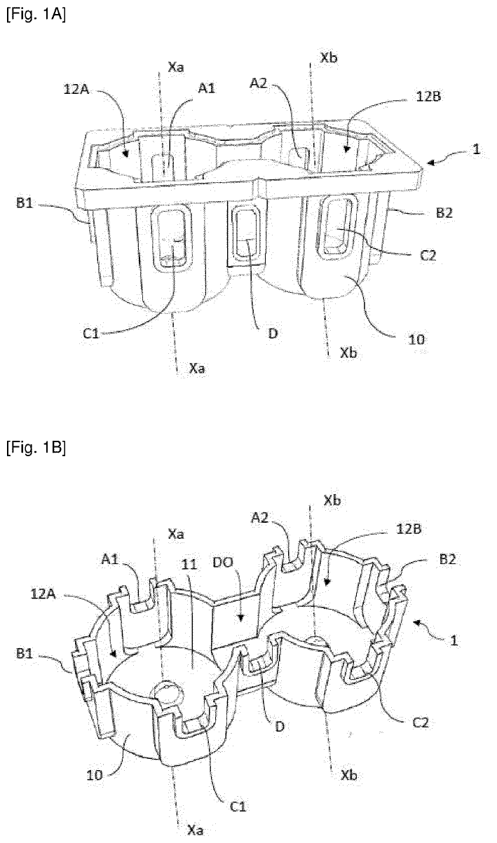

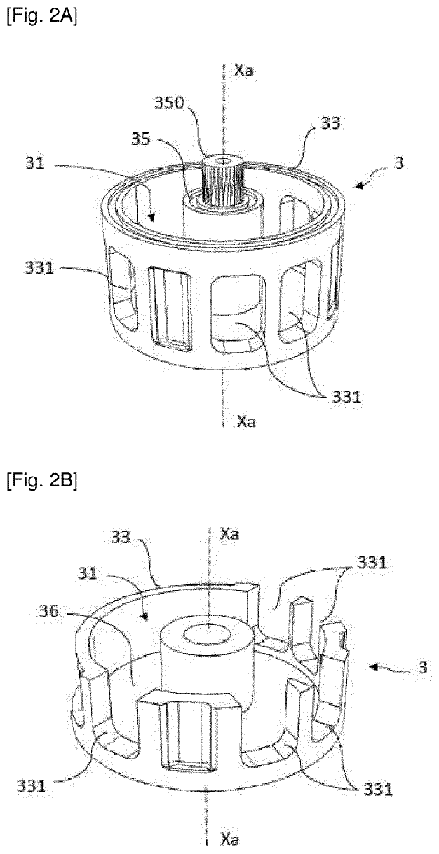

Referring to FIGS. 1A and 1B, the valve V which is the subject of the invention comprises a body 1 composed of a lateral wall 10, of generally parallelepipedal shape, and a bottom wall 11. The body 1 has two internal housings 12A and 12B which extend from the bottom wall 11 to an open end of said body opposite said bottom wall. Each housing is generally cylindrical in shape, with respective axes Xa-Xa, Xb-Xb. These two axes are parallel.

The two housings 12A and 12B are adjacent and situated in the same plane, which plane is normal to the axes Xa-Xa and Xb-Xb. According to a preferred embodiment that simplifies the design of the valve, these two housings 12A, 12B are identical and arranged with mirror symmetry.

According to a preferred embodiment, the body 1 is a single piece made of a rigid material, for example steel, metal, plastic, etc.

Fluid inlet and/or outlet orifices A1, B1, C1, A2, B2, C2 are arranged in the lateral wall 10, which orifices open out on the one hand into the housings 12A, 12B and on the other hand onto the outer surface of said lateral wall. The orifices are divided into two series: a first series A1, B1, C1 installed at the level of the first housing 12A, and a second series A2, B2, C2 installed at the level of the second housing 12B.

In the appended figures, each series has three orifices, but more orifices can be provided at the level of one and/or the other of the housings 12A, 12B. According to a preferred embodiment, the orifices A1, B1, C1 of the first series are positioned at 90° from each other, and the orifices A2, B2, C2 of the second series are advantageously positioned at 90° from each other. The two series are preferably arranged with mirror symmetry. The orifices A1, B1, C1, A2, B2, C2 can each be connected to a tube (not shown) which projects from the outer surface of the lateral wall 10.

A common channel or duct DO connects the first housing 12A and the second housing 12B, so as to allow fluidic communication between said housings. To optimize the overall size, this common channel or duct DO is advantageously arranged in the body 1, along the median plane of said body, which plane passes through the axes Xa-Xa and Xb-Xb.

The body 1 also has a common fluid inlet and/or outlet orifice D which opens, on the one hand, into the common channel or duct DO and, on the other hand, onto the outer surface of the lateral wall 10.

The valve further comprises two separate rotary members, a first member 3 mounted movably in rotation in the first housing 12A about the axis Xa-Xa, and a second member 4 mounted movably in rotation in the second housing 12B about the axis Xb-Xb. In use, these rotary members 3, 4 assume different angular positions in order to control the circulation of fluid between the orifices of the different series according to said angular positions. More specifically, since the orifices A1, B1, C1 of the first series are in fluidic communication with the first housing 12A, the first member 3 is adapted to control the circulation of fluid between the orifices of said first series. Since the orifices A2, B2, C2 of the second series are in fluidic communication with the second housing 12B, the second member 4 is adapted to control the circulation of fluid between the orifices of said second series.

### First Rotary Member

The first member 3 is configured so as to have angular positions making it possible to control the circulation of fluid, at the level of the first housing 12A, between at least two orifices A1, B1, C1 of the first series and/or between at least one orifice of said first series and the common channel or duct DO. The first member 3 is also advantageously configured so as to have at least one angular position preventing any circulation of fluid between the various orifices A1, B1, C1 of the first series and/or any circulation of fluid between at least one orifice of said first series and the common channel or duct DO.

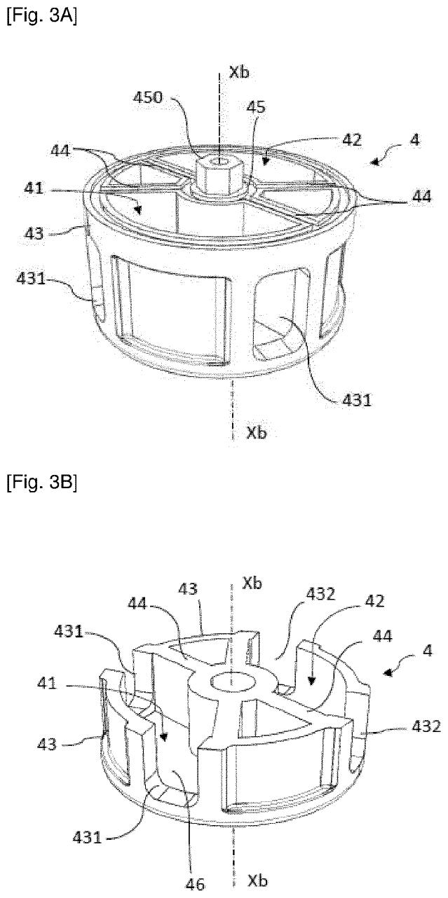

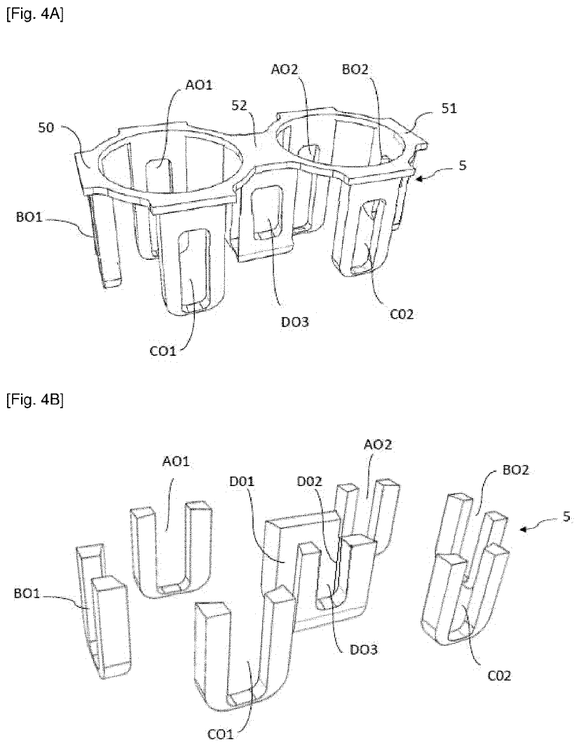

FIGS. 2A and 2B illustrate the first member 3 according to a preferred embodiment. This member 3 is composed of a lateral partition 33, of generally cylindrical shape with axis Xa-Xa, and of a bottom wall 36. Its external diameter substantially corresponds to that of the first housing 12A. It comprises a central cavity 31, of annular shape, surrounded by the partition 33. A central part forming a rotation shaft 35 is disposed at the center of the cavity 31. Referring to FIG. 2A, the shaft 35 has a tenon 350 projecting axially and comprising one or more splines. This tenon 350 is adapted to engage with a first actuator 8A described further on in the description.

The partition 33 comprises apertures 331 complementary to the orifices A1, B1, C1 of the first series and to the common channel or duct DO. These apertures open on the one hand into the cavity 31 and on the other hand into the outer surface of the partition 33. In FIGS. 2A and 2B, the member 3 has five apertures 331.

The distribution of the apertures 331 in FIGS. 2A and 2B is as follows (in a clockwise direction): two first adjacent apertures distributed over 60°, a first solid portion covering 30°, two adjacent second apertures distributed over 60°, a second solid portion covering 30°, a third aperture distributed over 30°, and a solid portion covering 150° and situated between the third aperture and the first apertures. However, other configurations can be envisioned depending on the desired operating modes, it being possible in particular to envision a greater or lesser number of apertures and/or of solid portions.

The upper edges of the partition 33 and of the rotation shaft 35 are advantageously ribbed so as to receive a seal (not shown) ensuring the sealing of the cavity 31 when the valve is assembled.

### Second Rotary Member

The second member 4 is configured so as to have angular positions making it possible to control the circulation of fluid, at the level of the second housing 12B, between at least two orifices A2, B2, C2 of the second series and/or between at least one orifice of said second series and the common channel or duct DO. The second member 4 is also advantageously configured so as to have at least one angular position preventing any circulation of fluid between the various orifices A2, B2, C2 of the second series and/or any circulation of fluid between at least one orifice of said second series and the common channel or duct DO.

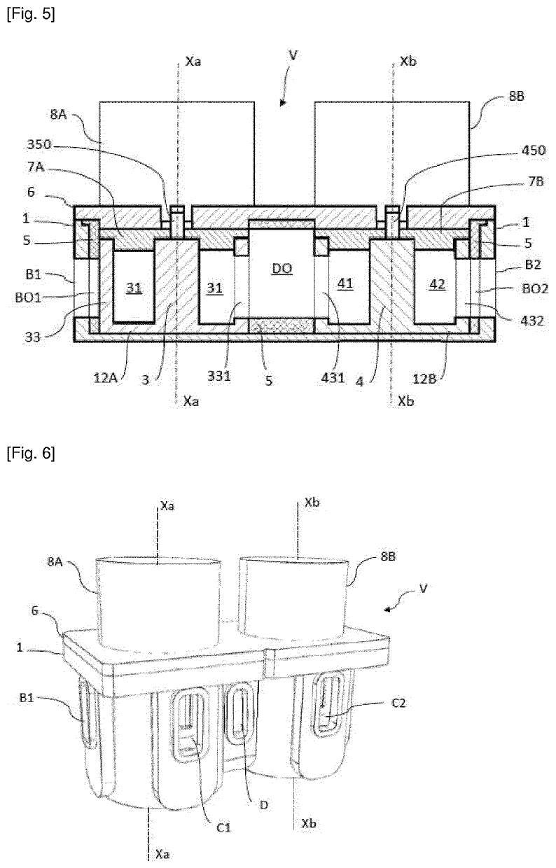

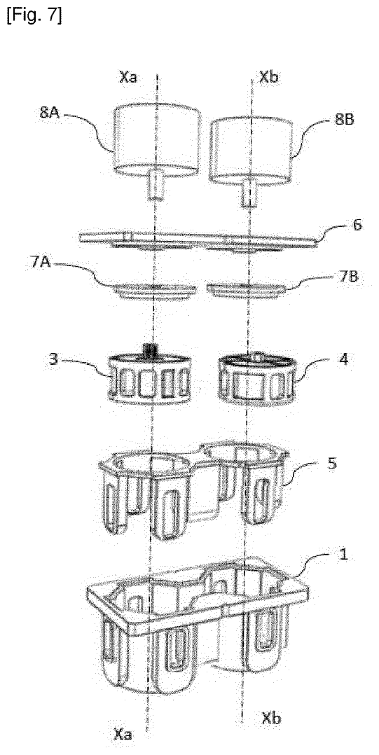

FIGS. 3A and 3B illustrate the second member 4 according to a preferred embodiment. This member 4 consists of a lateral partition 43, of generally cylindrical shape with axis Xb-Xb, and of a bottom wall 46. Its external diameter substantially corresponds to that of the housing 12B. It comprises two separate cavities without fluidic communication between them, respectively 41, 42, surrounded by the partition 43. Internal partitions 44 make it possible to isolate the two cavities 41, 42. In FIGS. 3A and 3B, the partitions 44 extend diagonally across the member 4, from an inner surface of the partition 43 toward a central part forming a rotation shaft 45.

The partition 43 comprises apertures 431, 432 complementary to the orifices A2, B2, C2 and to the common channel or duct DO. These apertures open on the one hand into the cavities 41, 42 and on the other hand onto the outer surface of the partition 43. One or more apertures 431 are disposed in the first cavity 41, and one or more apertures 432 are disposed at the second cavity 42. In FIGS. 3A and 3B, the member 4 has four apertures 431, 432 offset by 90°, two apertures 431 being located at the first cavity 41, and two other apertures 432 being disposed at the second cavity 42. However, other configurations can be envisioned depending on the desired operating modes, it being possible in particular to envision a greater or lesser number of apertures and/or of solid portions.

The upper edges of the partitions 43, 44 and of the rotation shaft 45 are advantageously ribbed so as to receive a seal (not shown) ensuring the sealing of the cavities 41, 42 when the valve is assembled.

Referring to FIG. 3A, the shaft 45 has a tenon 450 projecting axially and comprising one or more splines. This tenon 450 is adapted to engage with a second actuator 8B described further on in the description.

### Sealing Element

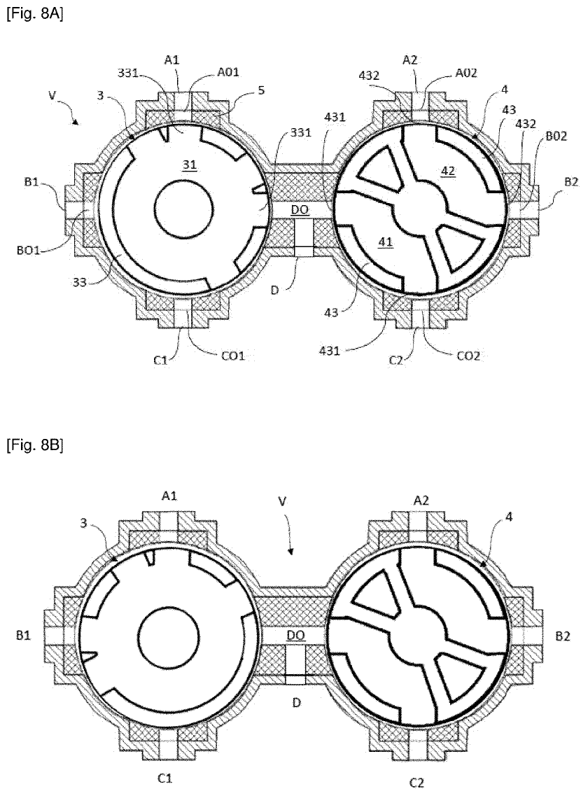

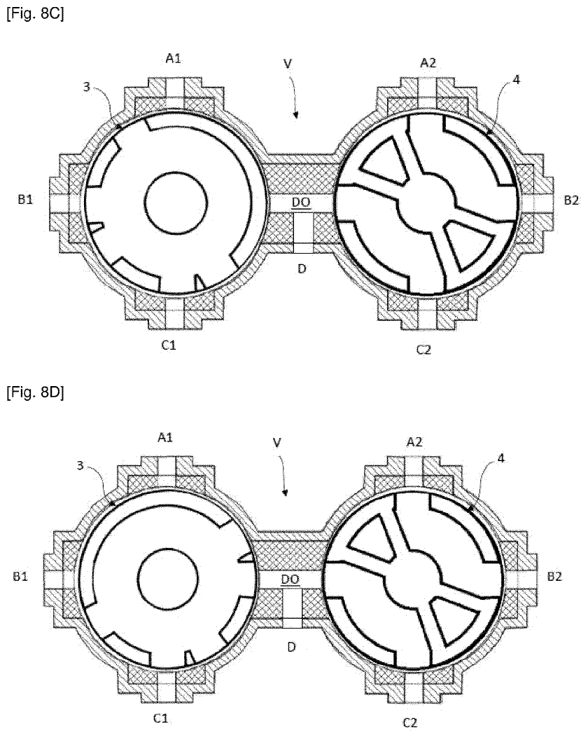

FIGS. 4A and 4B illustrate a sealing element 5 configured to be installed in the housings 12A and 12B, between the body 1 and the rotary members 3 and 4. It is advantageously in the form of a double sleeve 50, 51, the sleeves being complementary to the housings 12A and 12B and connected by a complementary connecting portion 52 of the channel DO. The contact between the outer surface of the element 5 and the inner wall of the housings 12A, 12B and of the channel DO is preferably a tight contact ensuring leaktightness.

According to an embodiment that simplifies the design and the assembly, the element 5 is a one-piece component. It is preferably made of a flexible material, for example of the rubber or elastomer type, so as to form a seal to the fluid between the body 1 and the rotary members 3, 4.

At the level of the first sleeve 50, the element 5 has first openings AO1, BO1, CO1 complementary to the orifices A1, B1, C1 of the first series, such that when said element is installed in the body 1, the orifice A1 opens into the opening AO1, the orifice B1 opens into opening BO1, and the orifice C1 opens into opening CO1. The openings AO1, BO1, CO1 are distinct from each other.

Second openings AO2, BO2, CO2 are also provided in the second sleeve 51. These second openings AO2, BO2, CO2 are complementary to the orifices A2, B2, C2 of the second series, such that when said element is installed in the body 1, the orifice A2 opens into the opening AO2, the orifice B2 opens into the opening BO2, and the orifice C2 opens into the opening CO2. The second openings AO2, BO2, CO2 are distinct from each other and distinct from the first openings AO1, BO1, CO1.

Openings DO1, DO2 are formed in the connecting portion 52 and open respectively into the first housing 12A and into the second housing 12B. The connecting portion 52 also has an opening DO3 complementary to the orifice D so that when said element is installed in the body 1, the orifice DO3 opens into the opening D.

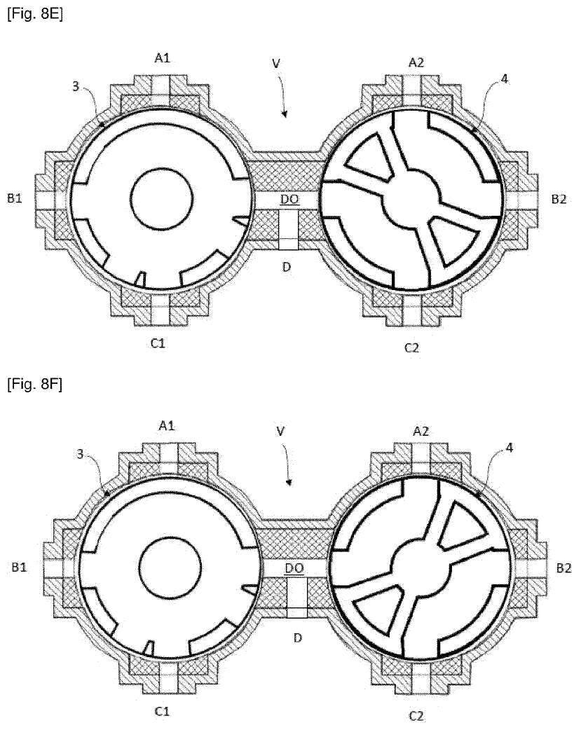

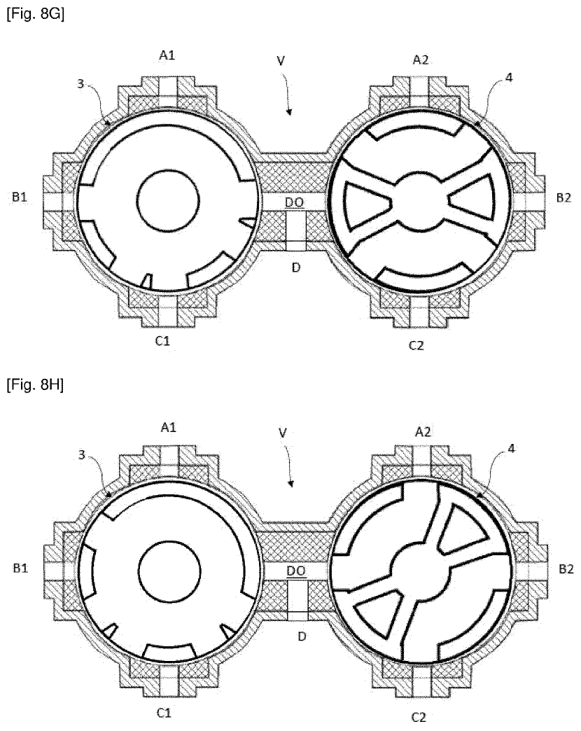

FIGS. 5 and 6 illustrate the assembled valve V. The rotary members 3 and 4 are installed in the housings 12A and 12B, the sealing element 5 being integrated into the body 1. The tenon 350 of the first member 3 is engaged with the shaft of a first actuator 8A, and the tenon 450 of the second member 4 is engaged with the shaft of a second actuator 8B.

The actuators 8A, 8B are of the rotary motor type, each ensuring the rotation of a member 3, 4. The latter can have the same number of angular positions and can be pivoted simultaneously. However, the fact of having two distinct actuators offers the advantage of being able to independently control each of the members 3, 4, with a different number of angular positions and/or with different speeds, so as to adapt with great flexibility to the different desired operating modes. For example, the first member 3 may have four different angular positions and the second member 4 only two.

According to a variant embodiment, a single common actuator can ensure the simultaneous rotation of the two members 3 and 4, in particular by way of a device with gears or pinions meshing with said members and more particularly with the shafts 35, 45 and/or with the tenons 350, 450. The gears or pinions can be configured and arranged to drive the members 3, 4 simultaneously in identical angular positions (for example) 30° or in different angular positions or, in other words, in first increments for the first member 3 (for example, increments of) 30° and in second increments for the second member 4 (for example, increments of 90° or) 180°.

In FIGS. 5 and 6, the actuators 8A, 8B are fixed to a cover 6, which cover closes the valve body 1 in a leaktight manner by cooperating with the sealing element 5 or with other dedicated sealing elements. According to a variant embodiment, each actuator 8A, 8B is fixed to its own cover.

According to one embodiment, the cavity 31 of the first member 3 is closed in a leaktight manner by a first sealing cover 7A, and the cavities 41 and 42 of the second member 4 are closed in a leaktight manner by a second sealing cover 7B. These covers 7A and 7B each have an opening allowing the tenon 350 and the tenon 450, respectively, to pass through. According to another embodiment, the cavities 31, 41 and 42 are closed in leaktight manner by a common cover, which can be the aforementioned cover 6 or another dedicated cover. However, closure of the cavities 31, 41 and 42 by the two covers 7A and 7B makes it possible to facilitate interventions (for example repair and/or replacement of the members 3, 4) on only part of the valve V, in particular at the housing 12A or 12B. Conversely, the presence of a single common cover simplifies and facilitates the assembly of the valve V.

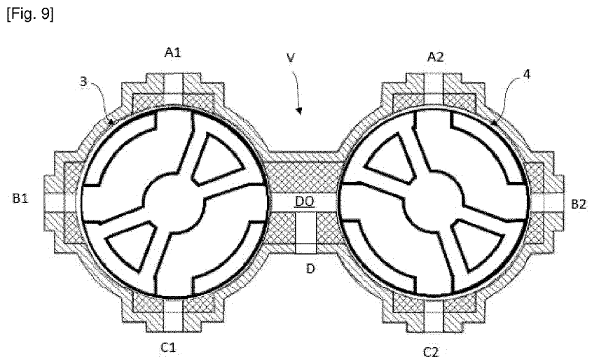

FIG. 7 is an exploded view of the valve V, showing the various component elements of the latter.

### Examples of Operating Modes of the Valve

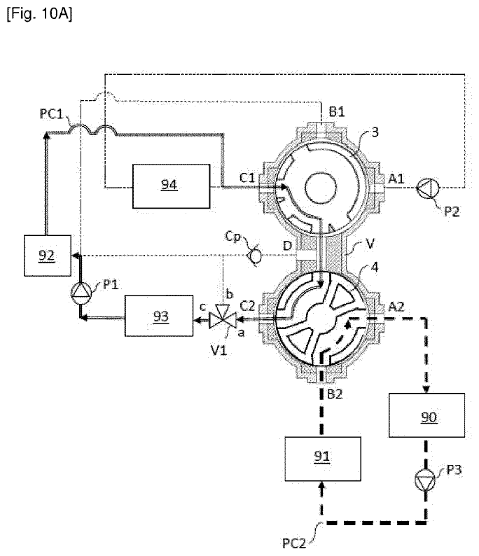

FIGS. 8A to 8H schematically illustrate the operation of the valve V in different angular positions of the rotary members 3 and 4. In these examples, the valve V operates by separate rotations of the rotary members 3 and 4.

Table 1 below summarizes the fluidic communications between the orifices of the first series A1, B1, C1 and/or of the second series A2, B2, C2 in different angular positions. A rotary member is said to be active when the fluid is able to pass through it.

For example, in the example of FIG. 8G, the second member 4 is in an angular position where the solid portions of the partition 43 are located opposite the openings AO2, BO2, CO2 and the common channel DO so as to prevent the circulation of fluid between the apertures of said member. The second member 4 is therefore inactive. Conversely, the first member 3 is in an angular position in which its apertures are situated opposite the openings BO1, CO1 and the common channel DO so as to allow fluid to circulate through said member. The first member 3 is therefore active.

TABLE 1

| | | Active rotary |
|---|---|---|
| FIG. | Valve orifices in fluidic communication | member |
| 8A | A1, C2, D | 3 and 4 |
| | A2, B2 | |
| 8B | A1, B1 | 3 and 4 |
| | C2, D | |
| 8C | B1, C1 | 3 and 4 |
| | C2, D | |
| | A2, B2 | |
| 8D | C1, C2, D | 3 and 4 |
| | A2, B2 | |
| 8E | B1, C1, C2, D | 3 and 4 |
| | A2, B2 | |
| 8F | B1, C1, A2, D | 3 and 4 |
| | B2, C2 | |
| 8G | B1, C1, D | 3 |
| 8H | A2, D | 4 |
| | B2, C2 | |

[Table 1] illustrates the large number of possible combinations of fluidic connection of the orifices offered by the valve V, compared to multi-way valves of the prior art. Each combination provides a particular mode of operation, examples of which are described further below in the description.

In the configurations of FIGS. 8A, 8B, 8D-8F and 8H, two distinct fluid circulation circuits are formed through the valve. For example, in the configuration of FIG. 8A, a first circuit runs between the orifices A1, C2, D, and a second circuit runs between the orifices A2 and B2. In the configuration of FIG. 8H, a first circuit runs between the orifices A2 and D, and a second circuit runs between the orifices B2 and C2. It is thus possible for a fluid of a first type (for example a high-temperature heating liquid) to circulate in a first circuit and for a fluid of a second type (for example air or a refrigerant liquid) to circulate in the second circuit.

In the case of FIG. 8C, three distinct fluid circulation circuits are formed through the valve. A first circuit runs between the orifices B1 and C1, a second circuit runs between the orifices C2 and D, and a third circuit runs between the orifices A2 and B2, so that three fluids of distinct nature can circulate through the valve.

In FIGS. 8A to 8H, the first member 3 adopts five angular positions, and the second member 4 adopts two angular positions. It will be understood that the members 3 and/or 4 can adopt a greater or lesser number of angular positions in order to adapt to other modes of operation.

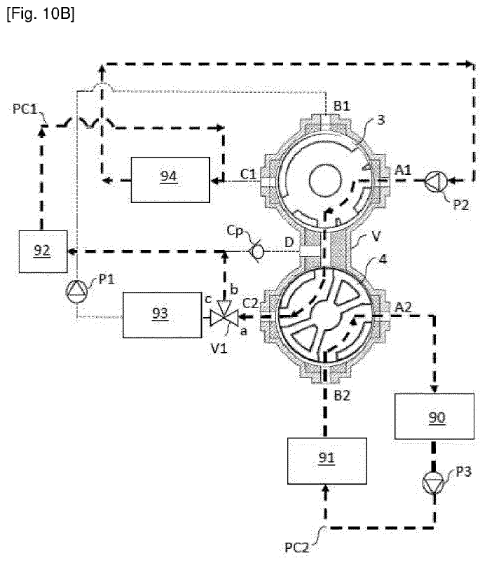

It will also be understood that by modifying the configuration of one or more of the rotary members 3, 4, other combinations of fluidic connections of the orifices can be obtained. In the example of FIG. 9, the two rotary members 3, 4 have the same configuration, in particular the one described with reference to FIGS. 3A and 3B. In the respective angular positions of the members 3 and 4, a first circuit runs between the orifices A1 and B1, a second circuit runs between the orifices C1, C2 and D, and a third circuit runs between the orifices A2 and B2.

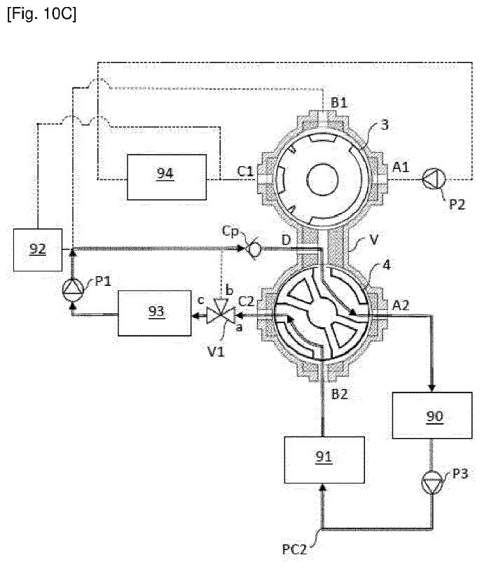

FIGS. 10A, 10B and 10C illustrate a fluid circulation circuit in a heat exchanger system of a motor vehicle according to different operating modes. This circuit comprises the valve V, an engine 90, a pack of electric batteries 91, a heat exchanger 92 used for heating (or cooling) the passenger compartment, an air conditioning cooler 93, and a heating element 94 (for example an electric heating radiator). Various pumps P1, P2, P3 allow the fluid to be circulated in the various branches of the circuit. A three-way valve V1 makes it possible to control the circulation in the various branches. A valve flap Cp serves to control the admission of the fluid at the orifice D and to prevent its discharge. The valve V according to the invention makes it possible to replace several three-way valves with a single valve, thus reducing the overall size and simplifying the assembly.

In FIG. 10A, the valve V is in the position of FIG. 8D. The orifices C1 and C2 are in fluidic communication by way of the rotary members 3 and 4 and the common channel DO; and the orifices A2 and B2 are in fluidic communication by way of the second member 4. The orifices A1 and B1 are closed off by the first member 3. The valve flap Cp blocks the discharge of the fluid from the channel DO through the orifice D. The valve V1 is in a position in which its paths a and c are open and the path b closed. The pumps P1 and P3 are activated and the pump P2 deactivated. In this configuration, two circulation circuits PC1 and PC2 are formed, in each of which a fluid of a distinct type can circulate. By way of the first circuit PC1, the passenger compartment is cooled by means of the heat exchanger 92, in which there circulates a cooling fluid cooled by the cooler 93. Moreover, the batteries 91 are heated by a heat transfer fluid circulating through the engine 90, in the second circuit PC2.

In FIG. 10B, the valve V is in the position of FIG. 8A. The orifices A1 and C2 are in fluidic communication by way of the rotary members 3 and 4 and the common channel DO; and the orifices A2 and B2 are in fluidic communication by way of the second member 4. The orifices B1 and C1 are closed off by the first member 3. The valve flap Cp blocks the discharge of the fluid from the channel DO through the orifice D. The valve V1 is in a position in which its paths a and b are open and the path c closed. The pumps P2 and P3 are activated and the pump P1 deactivated. In this configuration, by way of the first circuit PC1, the passenger compartment is heated by means of the heat exchanger 92, in which there circulates a heat transfer fluid heated by the heating element 94. Moreover, the batteries 91 are heated by a heat transfer fluid circulating through the engine 90, in the second circuit PC2.

In FIG. 10C, the valve V is in the position of FIG. 8H. The orifices D and A2 are in fluidic communication by way of the second member 4; and the orifices B2 and C2 are in fluidic communication by way of said second member. The orifices A1, B1 and C1 are closed off by the first member 3. The valve flap Cp allows the fluid to enter through the orifice D. The valve V1 is in a position in which its paths a and c are open and the path b closed. The pumps P1 and P3 are activated and the pump P2 deactivated. In this configuration, a single circuit PC2 is formed. The engine 90 and the batteries 91 are cooled by a cooling fluid circulating through the cooler 93.

It will be understood that other modes of operation can be envisioned with other fluid circulation circuits.

It will also be noted that the pumps P1, P2, P3, the valve V1 and the valve flap Cp form devices for regulating the circulation of the fluid, making it possible to block or allow circulation of the fluid from or to one or more orifices of the first series and/or of the second series. Further regulating devices can be installed in the first circuit PC1 and/or the second circuit PC2 according to requirements.

The arrangement of the various elements and/or means and/or steps of the invention, in the embodiments described above, must not be interpreted as demanding such an arrangement in all implementations. In any case, it will be appreciated that various modifications may be made to these elements and/or means and/or steps without departing from the spirit and scope of the invention. In particular:
The body 1 is not necessarily in one piece; the bottom wall 11, for example, can be attached.
The valve can comprise more adjacent housings, for example three, four or five housings situated in the same plane, each of said stages being associated with a rotary member.
The common channel or duct DO is not necessarily arranged along the median plane of the body 1 and can be made elsewhere in the wall 10.
The openings A1 and/or B1 and/or C1 and/or A2 and/or B2 and/or C2 and/or D are not necessarily arranged on the lateral wall 10. They may, for example, be arranged on the bottom wall 11 and/or at the level of the cover 6 or the covers 7A, 7B.
The orifices A1, B1, C1 of the first series and/or the orifices A2, B2, C2 of the second series are not necessarily positioned at 90° from each other.
The sealing element 5 is not necessarily in one piece but can be made in several separate parts. In addition, the leaktightness can also be achieved, for example, by seals provided in the housings 12A, 12B and/or on the rotary members 3, 4.
The members 3, 4 can have other configurations, each member being configured according to the desired operating modes.
The first housing 12A and/or the second housing 12B can comprise several rotary members installed on stages distinct from each other and situated in parallel planes. For example, the first housing 12A can comprise two separate first rotary members mounted so as to move in rotation about the axis of rotation Xa-Xa and installed respectively at a first stage and at a second stage. The orifices A1, B1, C1 of the first series are in fluidic communication with the first stage and with the second stage so that the two first rotary members are adapted to control the circulation of fluid between the orifices of said first series. Alternatively or in a complementary manner, the second housing 12B can comprise two separate second rotary members mounted so as to move in rotation about the axis of rotation Xb-Xb and installed respectively at a first stage and at a second stage. The orifices A2, B2, C2 of the second series are in fluidic communication with the first stage and with the second stage so that the two second rotary members are adapted to control the circulation of fluid between the orifices of said second series. This embodiment makes it possible to increase the circulation paths through the valve V and the desired operating modes.

Furthermore, one or more of the features set out in just one embodiment may be combined with one or more other features set out in just one other embodiment. Likewise, one or more features set out in just one embodiment may be generalized to the other embodiments, even if this or these features are described only in combination with other features.

The use of the verb “comprise” or “include” and conjugated forms thereof does not rule out the presence of other elements or other steps in addition to those stated in a claim.

1. A multi-way valve comprising:
a one-piece valve body in which is arranged a first housing, and a first series of fluid inlet and/or outlet orifices, said orifices opening into said first housing;
a first rotary member mounted movably in rotation in the first housing about a first axis of rotation, such that said first member adopts different angular positions,
wherein said first member is adapted to control a circulation of fluid between the orifices of said first series according to said angular positions;
a second housing is arranged in the body, which second housing is adjacent to the first housing and is located in a same plane as said first housing;
a second series of fluid inlet and/or outlet orifices is arranged in the body,
wherein said orifices opening into the second housing;
a second rotary member is mounted movably in rotation in the second housing about a second axis of rotation which is distinct from and parallel to the first axis of rotation, such that said second member adopts different angular positions,
wherein said second member is adapted to control the circulation of fluid between the orifices of the second series according to said angular positions;
a common channel or duct connects the first and second housings so as to allow fluidic communication between said housings; and
a common fluid inlet and/or outlet orifice is arranged in the body, which orifice opens on the one hand into the common channel or duct and on the other hand onto an outer surface of said body.

2. The multi-way valve as claimed in claim 1, wherein a first actuator rotates the first rotary member, and a second actuator, separate from said first actuator, rotates the second rotary member.

3. The multi-way valve as claimed in claim 1, wherein a common actuator causes the first rotary member and the second rotary member to rotate simultaneously by way of a gear or pinion device engaged with said members.

4. The multi-way valve as claimed in claim 1, wherein the first rotary member is configured to have angular positions allowing circulation of fluid between at least two orifices of the first series and/or between at least one orifice of said first series and the common channel or duct.

5. The multi-way valve as claimed in claim 1, wherein the second rotary member is configured to have angular positions allowing circulation of fluid between at least two orifices of the second series and/or between at least one orifice of said second series and the common channel or duct.

6. The multi-way valve as claimed in claim 1,
wherein the first rotary member has a central cavity surrounded by a partition,
wherein said partition comprising two adjacent first apertures distributed over 60°, a first solid portion covering 30°, two adjacent second apertures distributed over 60°, a second solid portion covering 30°, a third aperture distributed over 30°, a solid portion covering 150° and located between the third aperture and the first apertures, which apertures complement the orifices of the first series and the common channel or duct.

7. The multi-way valve as claimed in claim 1,
wherein the second rotary member has two separate cavities without fluidic communication between said cavities, which cavities are surrounded by a partition,
wherein said partition comprising four apertures offset by 90° complementary to the orifices of the second series and the common channel or duct,
wherein two apertures being are arranged at a level of the first cavity and two apertures are arranged at a level of the second cavity.

8. The multi-way valve as claimed in claim 1, wherein a sealing element is installed in the common channel or duct and in the housings between the valve body and the rotary members, which sealing element has first openings complementary to the orifices of the first series and second openings complementary to the orifices of the second series, so as to form a seal to the fluid between, on the one hand, the first rotary member and the orifices of said first series and, on the other hand, between the second rotary member and the orifices of said second series.

9. The multi-way valve as claimed in claim 8, wherein the sealing element comprises a connecting portion complementary to the common channel or duct, which connecting portion has two openings that open respectively into the first housing and into the second housing, so as to form a seal to the fluid between, on the one hand, the first rotary member and said common channel or duct and, on the other hand, between the second rotary member and said common channel or duct.

10. The multi-way valve as claimed in claim 6,
wherein the central cavity of the first rotary member is closed in a leaktight manner by a first sealing cover, and the cavities of the second rotary member are closed in a leaktight manner by a second sealing cover, or
wherein the central cavity of the first rotary member and the cavities of the second rotary member are closed in a leaktight manner by a common sealing cover.

11. The multi-way valve as claimed in claim 2, wherein the actuator or actuators are fixed to a cover that closes the valve body in a leaktight manner.

12. A heat exchanger system comprising:
a heat exchanger;
a first fluid circulation circuit; and
a second fluid circulation circuit,
wherein the first circuit and the second circuit are connected to the multi-way valve as claimed in claim 1,
wherein orifices of the first series are fluidically connected to the first circuit, and orifices of the second series are fluidically connected to the second circuit.

13. The heat exchanger system as claimed in claim 12, wherein the first circuit and/or the second circuit comprise one or more devices for regulating the circulation of the fluid, said one or more devices are arranged to block or permit circulation of the fluid from or to one or more orifices of the first and/or second series.

14. A motor vehicle comprising the heat exchanger system as claimed in claim 12 configured to allow cooling and/or heating of a passenger compartment of the vehicle and/or parts of said vehicle.
